(19) United States
(12) Patent Application Publication
(10) Pub. No.: US 2004/0050044 A1
(43) Pub. Date: Mar. 18, 2004

(54) Stirling engine

(76) Inventor: Yoshiaki Ogura, Osaka (JP)

Correspondence Address: BIRCH STEWART KOLASCH & BIRCH, PO BOX 747, FALLS CHURCH, VA, 22040-0747, US

(21) Appl. No.: 10/399,894

(22) PCT Filed: Oct. 19, 2001
(86) PCT No.: PCT/JP01/09232

(30) Foreign Application Priority Data
Oct. 23, 2000 (JP) 2000-322624

(51) Int. Cl. F02G 1/04; F01B 29/10

(52) U.S. Cl. 60/517

(57) ABSTRACT

A free-piston type Stirling engine used for producing cold heat with the vibration center position of a piston accurately kept. A first space is formed on one side of a piston, and a second space is formed on the opposite side to spread up to a portion adjacent to a cylinder's side wall. A piston is provided with a vibration-direction first groove extending up to the first space and a circumferential-direction second groove, and a cylinder is provided with a hole penetrating the side wall thereof The second groove of the piston, when coupled with the cylinder's hole during a piston vibration process, allows the first space to communicate with the second space. Accordingly, a short-time communication between the first and second spaces will balance pressures in the two spaces against each other to keep the vibration center position of the piston accurately.

### TECHNICAL FIELD

The present invention relates to a Stirling-cycle engine used to produce cold (cryogenic heat), and more particularly to a Stirling-cycle engine that can precisely maintain the center position of the reciprocating movement of the piston thereof.

### BACKGROUND ART

A free-piston-type Stirling-cycle engine designed for the production of cold is also called a reversed-Stirling-cycle engine in terms of the thermodynamic cycle on which it is based. FIG. 10 shows a sectional view of a conventional Stirling-cycle engine. A typical Stirling-cycle engine has a piston 1 and a displacer 2 that reciprocate linearly inside a cylinder 3. The piston 1 and the displacer 2 are arranged coaxially, and a rod 2a formed on the displacer 2 penetrates the piston 1 through a slide hole 1a formed at its center. Thus, the piston 1 and the displacer 2 are smoothly slidable along the cylinder inner slide surface 3a. Moreover, the piston 1 and the displacer 2 are resiliently supported on a pressure vessel 4 by a piston support spring 5 and a displacer support spring 6 respectively.

The space formed by the cylinder 3 is divided into two spaces by the piston 1. One of these spaces is a working space (a first and a third spaces) 7 located on that side of the piston 1 which faces the displacer 2, and the other is a back space (a second space) 8 located on that side of the piston 1 which faces away from the displacer 2. These spaces are filled with a working medium such as helium gas. The piston 1 is made to reciprocate with a predetermined period by an piston driving member, not shown, such as a linear motor. Thus, the working medium is compressed or expanded in the working space 7. The displacer 2 is made to reciprocate linearly by the change in the pressure of the working medium compressed or expanded in the working space 7. Here, the piston 1 and the displacer 2 are typically so designed as to reciprocate with the same period but with a 90°.

The working space 7 is further divided into two spaces by the displacer 2. One of these spaces is the first space 7a located between the piston 1 and the displacer 2, and the other is the third space 7b located at the tip of the cylinder 3. These two spaces are connected together through a regenerator 9, which is typically formed out of copper in the form of mesh. The working medium in the third space 7b produces cold at the tip, called the cold head, of the cylinder 3. The principles of the reversed Stirling thermodynamic cycle, as by what mechanism cold is produced here, are well known, and therefore no explanation will be given in these respects.

Between the cylinder slide surface 3a and the piston slide surface 1b, a sealing means, not shown, for shielding the first space 7a and the second space 8 from each other is provided. As the shielding means is typically used an inexpensive seal ring with a simple structure. However, owing to various factors, such as the influence of thermal expansion and the wear of the seal ring after a prolonged period of operation, perfect sealing is impossible here, and thus a very small gap appears between the cylinder slide surface 3a and the piston slide surface 1b. When the engine is driven, the piston 1 reciprocates and produces changes in the pressure of the working medium in the first space 7a and the second space 8. The resulting pressure difference between these spaces causes the working medium to flow from one of those spaces to the other through the aforementioned very small gap. Specifically, when the pressure in the first space 7a is higher than that in the second space 8, the working medium flows from the first space 7a to the second space 8; when the pressure in the second space 8 is higher than that in the first space 7a, the working medium flows from the second space 8 to the first space 7a.

The very small gap appearing between the cylinder slide surface 3a and the piston slide surface 1b is not constant but varies according to the surface conditions of the slide components and the contact, wear, and other conditions of the seal ring. Thus, the inflow volume and the outflow volume of the working medium to and from the second space 8 as seen from the first space 7a are not exactly equal. For this reason, when the engine is driven continuously and the working medium leaks little by little from the first space 7a to the second space 8, the center position of the piston 1, which has initially been set so that equilibrium of pressure is achieved between the first space 7a and the second space 8, gradually moves toward the first space 7a, where the pressure is lower now. As a result, as the pressure of the working medium in the first space 7a lowers, problems arise, such as lower cooling performance than expected, or collision between the piston 1 and the displacer 2 resulting from the center position of the reciprocating movement of the piston 1 being displaced from the initially set position.

These problems may be solved by increasing the spring constant of the piston support spring 5 so as to increase the force supporting the piston 1. This, however, is not at all effective against the leakage of the working medium out of the first space 7a, and only invites an increase in the power required by the driving means for driving the piston 1, leading to an increase in the input electric power. This leads to another problem, lower cooling efficiency.

To solve this problem, Japanese Patent Application Laid-Open No. 2000-39222 discloses a method of reducing the variation of the center position of the reciprocating movement of the piston 1 by maintaining the equilibrium of pressure between the first space 7a and the second space 8. FIG. 11A shows a sectional view of the Stirling-cycle engine disclosed in Japanese Patent Application Laid-Open No. 2000-39222. The structure here is the same as that shown in FIG. 10 except for the shape of part of the piston 1. FIG. 11B is a perspective view of a portion around the piston 1 when the piston 1 is in the center position of its reciprocating movement as initially set. In the piston 1 are formed a first groove 10a that connects to the first space and runs in the direction of the reciprocating movement X of the piston 1 and a second groove 10b that is continuous with the first groove 10a and runs at an angle (in the figure, 90°) to the direction of the reciprocating movement X of the piston 1. In the cylinder 3 is formed a circular hole 12 that penetrates from the second groove 10b to the second space 8. The moment that the second groove 10b coincides with the circular hole 12 during the operation of the piston 1, the first space 7a and the second space 8 are momentarily connected together and permit the working medium to flow. This brings the pressure in those two spaces into equilibrium and thereby permits the piston 1 to reciprocate with the center position kept in the initially set position.

As described above, connecting the first space 7a and the second space 8 together by way of a minute flow passage when the piston 1 is in the center position of its reciprocating movement as initially set is effective in keeping the center position in the initially set position. However, to achieve higher cooling performance, it is necessary either to increase the number of cycles of the reciprocating movement of the piston 1 or to increase the amplitude of each cycle of the reciprocating movement of the piston 1. This inevitably increases the flow rate of the working medium between the first space 7a and the second space 8, and thus requires that the first and second grooves 10a and 10b have a larger cross-sectional area. Here, simply increasing the dimensions and cross-sectional area of the first and second grooves 10a and 10b makes the area over which the second groove 10b communicates with the second space 8 larger with respect to the working stroke of the piston 1, and also makes the time for which they communicate with each other longer.

Thus, it is possible to achieve equilibrium of pressure between the first space 7a and the second space 8, but it is not possible to keep the center position of the reciprocating movement of the piston 1 accurately in the initially set position. Moreover, a gas flow loss occurs in the first and second grooves 10a and 10b. This increases the input of power required to operate the piston 1, and thus makes it impossible to enhance the performance of the Stirling-cycle engine as expected.

### DISCLOSURE OF THE INVENTION

An object of the present invention is to provide a Stirling-cycle engine in which the center position of the reciprocating movement of its piston is stabilized by forming grooves in the piston easily and cheaply. Another object of the present invention is to provide a Stirling-cycle engine with a reduced gas flow loss from the working space. Still another object of the present invention is to provide a Stirling-cycle engine in which the flow of the working medium does not spoil the smooth sliding of the piston achieved by an air bearing.

To achieve the above objects, according to the present invention, a Stirling-cycle engine is provided with a piston that reciprocates inside a cylinder and a displacer that reciprocates inside the cylinder as a result of a working medium being compressed or expanded by the reciprocating movement of the piston, and the piston and the displacer are arranged so that their center axes coincide with the center axis of the cylinder. Moreover, the Stirling-cycle engine has a first space formed between the displacer and the piston, a second space formed so as to extend from the side of the piston facing away from the displacer and include a portion adjacent to at least part of the side wall of the cylinder, a third space formed on the side of the displacer facing away from the piston, a first groove formed so as to run from the end surface of the piston facing the first space in the direction of the reciprocating movement, and a second groove formed all around the periphery of the piston so as to start and end at one point on the first groove, and a hole formed through the side wall of the cylinder. This Stirling-cycle engine is so structured that, when the piston is in the center position of its reciprocating movement, the second grove and the hole connect to each other so that the first and second spaces communicate with each other. Here, the opening of the hole has the shape of an elongate circle or a rectangle having its minor axis or shorter sides aligned with the direction of the reciprocating movement of the piston. This helps shorten the time for which the second groove and the hole connect to each other during the reciprocating movement of the piston.

Alternatively, a Stirling-cycle engine is provided with a piston that reciprocates inside a cylinder and a displacer that reciprocates inside the cylinder as a result of a working medium being compressed or expanded by the reciprocating movement of the piston, and the piston and the displacer are arranged so that their center axes coincide with the center axis of the cylinder. Moreover, the Stirling-cycle engine has a first space formed between the displacer and the piston, a second space formed so as to extend from the side of the piston facing away from the displacer and include a portion adjacent to at least part of the side wall of the cylinder, a third space formed on the side of the displacer facing away from the piston, a first groove formed so as to run from the end surface of the piston facing the first space in the direction of the reciprocating movement, and a second groove formed all around the periphery of the piston so as to start and end at one point on the first groove, and a hole formed through the side wall of the cylinder. This Stirling-cycle engine is so structured that, when the piston is in the center position of its reciprocating movement, the second grove and the hole connect to each other so that the first and second spaces communicate with each other. Here, the hole consists of a plurality of such holes arranged along the second groove. This permits the second groove and the holes to connect to each other at different points on the second groove simultaneously during the reciprocating movement of the piston.

Here, the second groove may be so formed that its depth is greater than its width as viewed in a cross section. This helps reduce the time for which the second groove and the hole connect to each other during the reciprocating movement of the piston.

Alternatively, the first groove may be so formed that its depth is greater than its width as viewed in a cross section. This helps reduce the proportion of the area occupied by the first groove relative to the surface area of the slide surface of the piston.

Alternatively, the first groove may be given increasingly large cross-sectional areas from one end thereof toward the end surface of the piston so that the first groove has the maximum cross-sectional area at the other end thereof facing the first space. This helps reduce the energy loss due to the flow of working medium.

The second groove may consist of a plurality of such grooves arranged along the first groove. This permits the second groove and the holes to connect to each other at different points on the second groove simultaneously during the reciprocating movement of the piston. Thus, it is possible to make the individual holes smaller, and make the cross-sectional area of the first and the second grooves smaller.

The second groove may consist of n such grooves arranged along the first groove, with the portions of the first groove between the root portion of the (n−1)th of the second grooves as counted from the first space side and the root portion of the nth of the second grooves as counted from the first space side given increasingly large cross-sectional areas from one end of the first groove toward the first space so that the first groove has the maximum cross-sectional area between the other end thereof facing the first space and the root portion of the first of the second grooves as counted from the first space side. This helps secure the minimum cross-sectional area of the first and second grooves required to permit the flow of the working medium. Thus, it is possible to minimize the energy loss due to the flow of the working medium that occurs when the first and second grooves and the holes connect to one another.

According to the present invention, a Stirling-cycle engine is provided with a piston that reciprocates inside a cylinder and a displacer that reciprocates inside the cylinder as a result of a working medium being compressed or expanded by the reciprocating movement of the piston, and the piston and the displacer are arranged so that their center axes coincide with the center axis of the cylinder. Moreover, the Stirling-cycle engine has a first space formed between the displacer and the piston, a second space formed so as to extend from the side of the piston facing away from the displacer and include a portion adjacent to at least part of the side wall of the cylinder, a third space formed on the side of the displacer facing away from the piston, a first groove formed so as to run from the end surface of the piston facing the first space in the direction of the reciprocating movement, and a second groove formed in the periphery of the piston so as to extend from one point on the first groove perpendicularly to the first groove, and a hole formed through the side wall of the cylinder. This Stirling-cycle engine is so structured that, when the piston is in the center position of its reciprocating movement, the second grove and the hole connect to each other so that the first and second spaces communicate with each other. Here, the opening of the hole has the shape of an elongate circle or a rectangle having its minor axis or shorter sides aligned with the direction of the reciprocating movement of the piston. This helps shorten the time for which the second groove and the hole connect to each other during the reciprocating movement of the piston.

Alternatively, a Stirling-cycle engine is provided with a piston that reciprocates inside a cylinder and a displacer that reciprocates inside the cylinder as a result of a working medium being compressed or expanded by the reciprocating movement of the piston, and the piston and the displacer are arranged so that their center axes coincide with the center axis of the cylinder. Moreover, the Stirling-cycle engine has a first space formed between the displacer and the piston, a second space formed so as to extend from the side of the piston facing away from the displacer and include a portion adjacent to at least part of the side wall of the cylinder, a third space formed on a side of the displacer facing away from the piston, a first groove formed so as to run from the end surface of the piston facing the first space in the direction of the reciprocating movement, and a pair of second grooves formed so as to branch off one point on the first groove in a fashion symmetric with respect to the first groove in the periphery of the piston, and a hole formed through the side wall of the cylinder. This Stirling-cycle engine being so structured that, when the piston is in the center position of its reciprocating movement, the second grove and the hole connect to each other so that the first and second spaces communicate with each other. Here, the hole consists of a plurality of such holes arranged for each of the pair of second grooves. This permits the second groove and the holes to connect to each other at different points on the second groove simultaneously during the reciprocating movement of the piston.

Here, the second groove may be so formed that its depth is greater than its width as viewed in a cross section. This helps reduce the time for which the second groove and the hole connect to each other during the reciprocating movement of the piston.

Alternatively, the first groove may be so formed that its depth is greater than its width as viewed in a cross section. This helps reduce the proportion of the area occupied by the first groove relative to the surface area of the slide surface of the piston.

Alternatively, the first groove may be given increasingly large cross-sectional areas from one end thereof toward the end surface of the piston so that the first groove has the maximum cross-sectional area at the other end thereof facing the first space. This helps reduce the energy loss due to the flow of working medium.

The second groove may consist of a plurality of such grooves arranged along the first groove. This permits the second groove and the holes to connect to each other at different points on the second groove simultaneously during the reciprocating movement of the piston. Thus, it is possible to make the individual holes smaller, and make the cross-sectional area of the first and the second grooves smaller.

The second groove may consist of n such grooves arranged along the first groove, with the portions of the first groove between the root portion of the (n−1)th of the second grooves as counted from the first space side and the root portion of the nth of the second grooves as counted from the first space side given increasingly large cross-sectional areas from one end of the first groove toward the first space so that the first groove has the maximum cross-sectional area between the other end thereof facing the first space and the root portion of the first of the second grooves as counted from the first space side. This helps secure the minimum cross-sectional area of the first and second grooves required to permit the flow of the working medium. Thus, it is possible to minimize the energy loss due to the flow of the working medium that occurs when the first and second grooves and the holes connect to one another.

### BRIEF DESCRIPTION OF DRAWINGS

FIG. 1A is a perspective view of the piston and the cylinder of a first embodiment of the invention;

FIG. 1B is a sectional view taken along line C-C shown in FIG. 1A.

FIG. 2 is a perspective view of the piston and the cylinder of a second embodiment of the invention.

FIG. 3 is a perspective view of the piston and the cylinder of a third embodiment of the invention.

FIG. 4 is a perspective view of the piston and the cylinder of a fourth embodiment of the invention.

FIG. 5 is a perspective view of the piston and the cylinder of a fifth embodiment of the invention.

FIG. 6A is a perspective view of the piston and the cylinder of a sixth embodiment of the invention.

FIG. 6B is a sectional view taken along line A-A shown in FIG. 6A.

FIG. 7A is a perspective view of the piston and the cylinder of a seventh embodiment of the invention.

FIG. 7B is a sectional view taken along line B-B shown in FIG. 7A.

FIG. 8 is a perspective view of the piston and the cylinder of an eighth embodiment of the invention.

FIG. 9A is a perspective view of the piston and the cylinder of a ninth embodiment of the invention.

FIG. 9B is a sectional view taken along line D-D shown in FIG. 9A.

FIG. 10 is a sectional view of a conventional Stirling-cycle engine.

FIG. 11A is a sectional view of another conventional Stirling-cycle engine.

FIG. 11B is a perspective view showing a portion around the piston of the conventional Stirling-cycle engine.

### BEST MODE FOR CARRYING OUT THE INVENTION

Hereinafter, practical embodiments of the present invention will be described with reference to the drawings. All the embodiments described below have the same structure as that described earlier as a conventional example except for the structure of the piston and cylinder. Therefore, overlapping explanations will not be repeated, and descriptions will be given only of the structure of the piston and the cylinder with reference to the drawings. It is to be noted that, in the following descriptions, a single cylinder acts both as a cylinder (a first cylinder) provided with a piston and as a cylinder (a second cylinder) provided with a displacer, but that the first and second cylinders may be arranged in any other manner as long as the reciprocating movement of the piston inside the first cylinder compresses or expands the working medium and thereby causes the displacer to reciprocate inside the second cylinder.

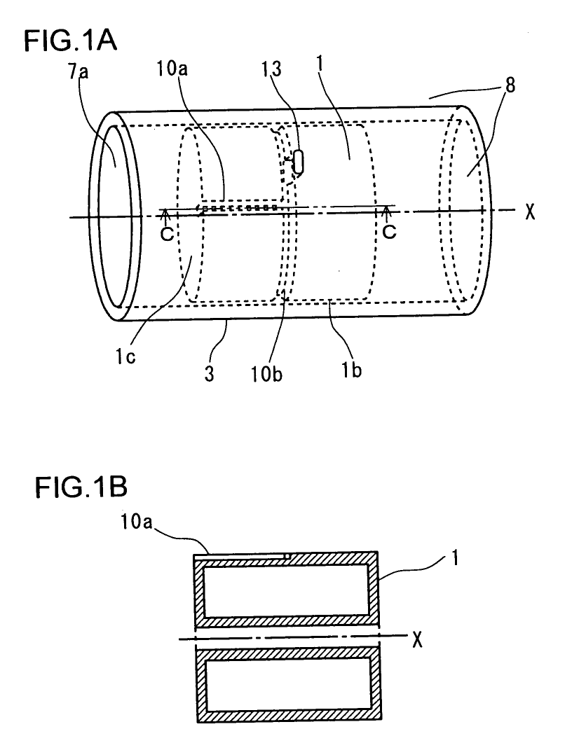

FIG. 1A is a perspective view of the piston and the cylinder of a first embodiment of the invention. Initially, the piston 1 is in the center position of its reciprocating movement where it is designed that equilibrium of pressure is achieved between the first space 7a and the second space 8. In the piston slide surface 1b, a first groove 10a is formed so as to run from the piston end surface 1c facing the first space 7a in the direction X of the reciprocating movement, and a second groove 10b is formed all around the periphery of the piston 1 so as to start and end at one point on the first groove 10a. Moreover, in the cylinder 3, a hole 13 is formed so as to penetrate from the second groove 10b to the second space 8. Thus, during the reciprocating movement of the piston 1, only the moment that the second groove 10b and the hole 13 communicate with each other, the first space 7a and the second space 8 communicate with each other so that equilibrium of pressure is achieved between the first space 7a and the second space 8. Since the second groove 10b is formed all around the periphery of the piston 1, even if the piston 1 rotates about its axis while moving, the second groove 10b can communicate with the hole 13.

Here, the opening of the hole 13 is formed in the shape of an elongate circle having its minor axis aligned with the direction X of the reciprocating movement, as one of shapes that make it possible to secure a cross-sectional area sufficient to achieve equilibrium of pressure between the first space 7a and the second space 8 while reducing the time for which those spaces communicate with each other when the piston 1 is driven to move. This reduces the time for which the second groove 10b and the hole 13 communicate with each other when the piston 1 is driven to move, and thus helps increase the accuracy of the center position of the movement of the piston 1. The opening of the hole 13 may be formed in any other shape as long as it helps shorten the time for which the second groove 10b and the hole 13 communicate with each other when the piston 1 is driven to move, for example a rectangle having its shorter sides aligned with the direction X of the reciprocating movement of the piston.

As shown in FIG. 1B, which is a sectional view taken along line C-C shown in FIG. 1A, the piston 1 is made hollow. This helps reduce the weight of the piston 1 and thereby make the design of the piston support spring 5 easier, and also helps reduce the amounts of materials used. To make the hollow portion of the piston 1 larger, it is advisable to make the depth of the first and second grooves 10a and 10b as small as possible. Making the piston 1 hollow in this way can be applied to all the embodiments of the invention to achieve the same effects.

FIG. 2 is a perspective view of the piston and the cylinder of a second embodiment of the invention. The piston 1 is in the center position of its reciprocating movement as initially set. In the piston slide surface 1b, a first grove 10a is formed so as to run from the piston end surface 1c facing the first space 7a in the direction X of the reciprocating movement, and a second groove 10b is formed all around the periphery of the piston 1 so as to start and end at one point on the first groove 10a. Moreover, in the cylinder 3, a plurality of (in FIG. 2, two) holes 14 are formed so as to penetrate from the second groove 10b to the second space 8. Since the second groove 10b is formed all around the periphery of the piston 1, even if the piston 1 rotates about its axis while moving, the second groove 10b can communicate with the hole 14.

Here, where a plurality of holes 14 are formed, by making the total of the diametrical cross-sectional areas of the holes 14 equal to the cross-sectional area of the single hole 14 in a case where only one hole 14 is formed, it is possible to make the individual holes 14 smaller and simultaneously make the cross-sectional area of the second groove 10b smaller. This helps shorten the time for which the second groove 10b and the holes 14 communicate with each other when the piston 1 is driven to move and thereby increase the accuracy of the center position of the movement of the piston 1. The opening of the holes 14 is formed in the shape of a circle, elongate circle, or rectangle.

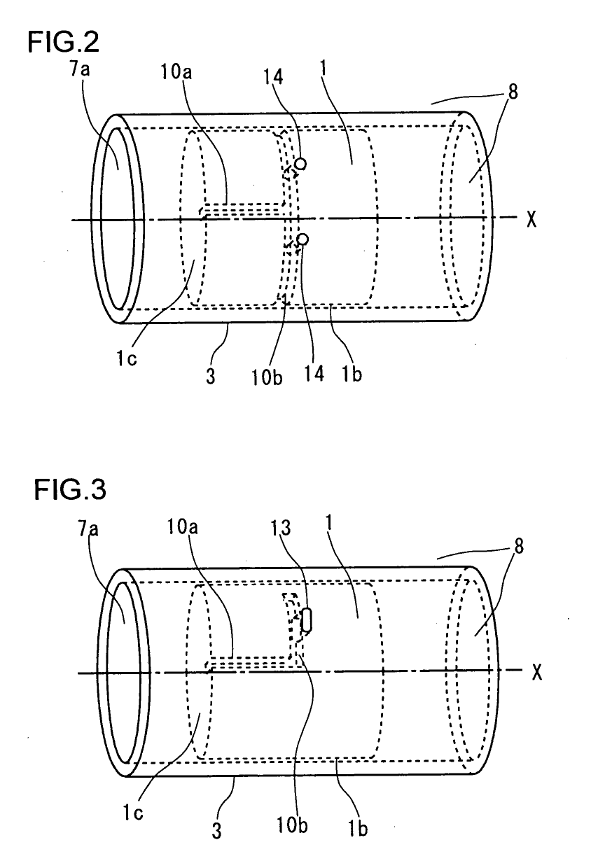

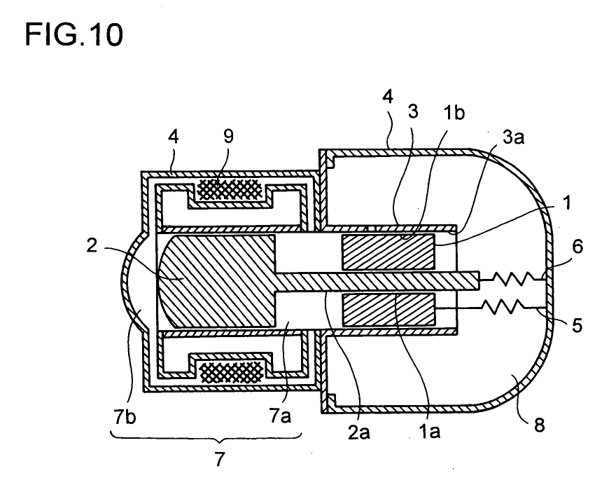

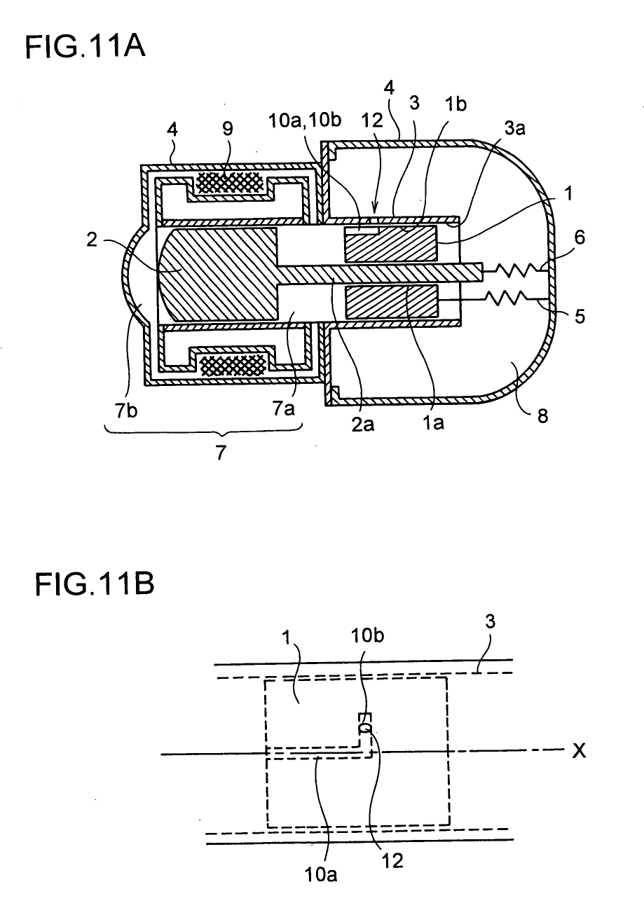

FIG. 3 is a perspective view of the piston and the cylinder of a third embodiment of the invention. The piston 1 is in the center position of its reciprocating movement as set initially, and is provided with a means (for example the piston support spring 5 shown in FIG. 10) for restricting the rotation of the piston 1 about its axis. In the piston slide surface 1b, a first grove 10a is formed so as to run from the piston end surface 1c facing the first space 7a in the direction X of the reciprocating movement, and a second groove 10b is formed in the periphery of the piston 1 so as to extend from one point on the first groove perpendicularly to the first groove (in FIG. 3, L-shaped). The second groove 10b is formed only where the hole 13 and the second groove 10b communicate with each other through the shortest path, and the opening of the hole 13 is formed in the shape of an elongate circle. The opening of the hole 13 may formed in any other shape as long as it helps shorten the time for which the second groove 10b and the hole 13 communicate with each other when the piston 1 is driven to move, for example a rectangle.

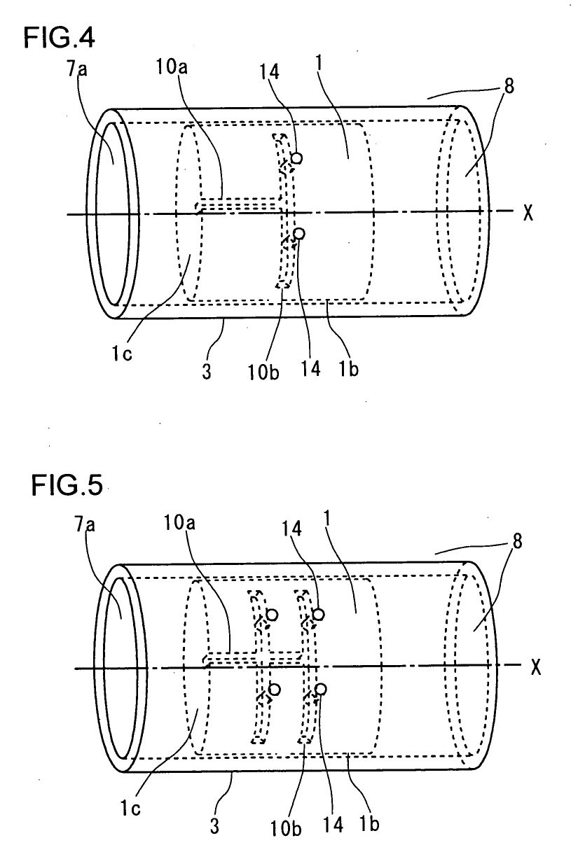

FIG. 4 is a perspective view of the piston and the cylinder of a fourth embodiment of the invention. The piston 1 is in the center position of its reciprocating movement as set initially, and is provided with a means (for example the piston support spring 5 shown in FIG. 10) for restricting the rotation of the piston 1 about its axis. In the piston slide surface 1b, a first grove 10a is formed so as to run from the piston end surface 1c facing the first space 7a in the direction X of the reciprocating movement, and a second groove 10b is formed in the periphery of the piston 1 so as to extend from one point on the first groove perpendicularly to the first groove (in FIG. 4, T-shaped). Moreover, in the second groove 10b, two or more holes 14 are formed, of which the opening is formed in the shape of a circle, elongate circle, or rectangle. The second groove 10b is formed only where the holes 14 communicate with the first groove 10a through the shortest path.

FIG. 5 is a perspective view of the piston and the cylinder of a fifth embodiment of the invention. The piston 1 is in the center position of its reciprocating movement as set initially, and is provided with a means (for example the piston support spring 5 shown in FIG. 10) for restricting the rotation of the piston 1 about its axis. In the piston slide surface 1b, a first grove 10a is formed so as to run from the piston end surface 1c facing the first space 7a in the direction X of the reciprocating movement, and a pair of second grooves 10b is formed in such a way that each branches off one point on the first groove in a fashion symmetric with respect to the first groove in the periphery of the piston 1. The two second grooves 10b are arranged along the first groove 10a. Moreover, in the cylinder 3, four holes 14 in total, i.e. two holes for each of the second grooves 10b, are formed. The opening of the holes 14 is formed in the shape of a circle, elongate circle, or rectangle. The second grooves 10b are formed only where the holes 14 communicate with the first groove 10a through the shortest path.

In the fourth and fifth embodiments of the invention, where a plurality of holes 14 are formed, by making the total of the diametrical cross-sectional areas of the holes 14 equal to the cross-sectional area of the single hole 14 in a case where only one hole 14 is formed, it is possible to make the individual holes 14 smaller and simultaneously make the cross-sectional area of the second groove 10b smaller. This helps shorten the time for which the second groove 10b and the holes 14 communicate with each other when the piston 1 is driven to move and thereby increase the accuracy of the center position of the movement of the piston 1.

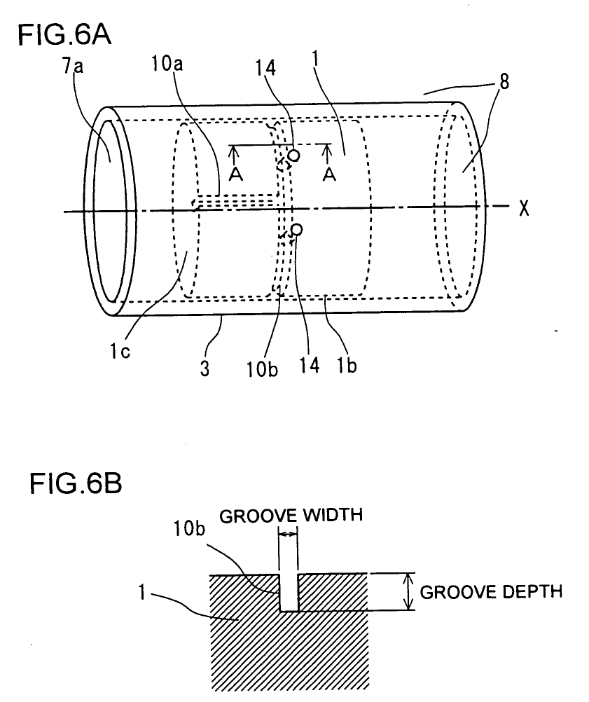

FIG. 6A is a perspective view of the piston and the cylinder of a sixth embodiment of the invention. Here, the piston 1, the first and second grooves 10a and 10b, and the holes 14 are arranged in the same manner as in the second embodiment. FIG. 6B is a sectional view taken along line A-A shown in FIG. 6A. The second groove 10b is so formed as to have a cross-sectional area required to permit the flow of the working medium and have a cross-sectional shape of which the depth is greater than the width. This helps shorten the time for which the second groove 10b and the holes 14 communicate with each other when the piston 1 is driven to move and thereby increase the accuracy of the center position of the movement of the piston 1.

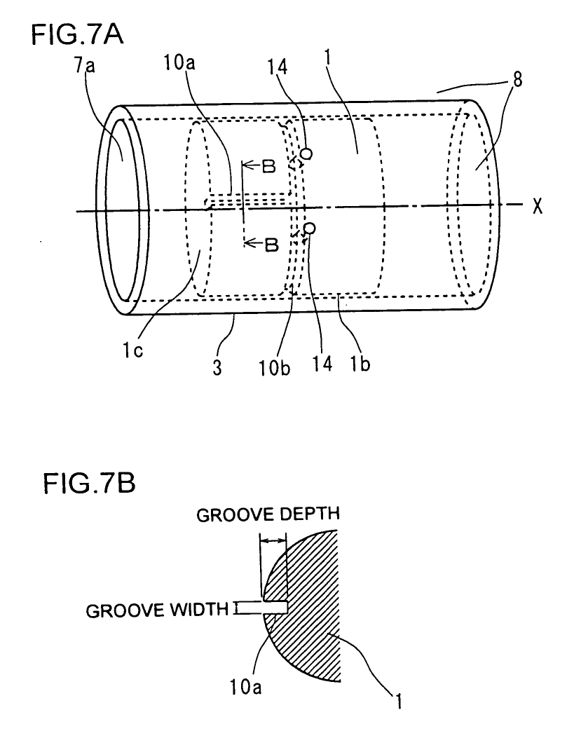

FIG. 7A is a perspective view of the piston and the cylinder of a seventh embodiment of the invention. The piston 1, the first and second grooves 10a and 10b, and the holes 14 are arranged in the same manner as in the second embodiment. FIG. 7B shows a sectional view taken along line B-B shown in FIG. 7A. The first groove 10a is so formed as to have a cross-sectional area required to permit the flow of the working medium and have a cross-sectional shape of which the depth is greater than the width. This helps reduce the area occupied by the first groove 10a relative to the surface area of the piston slide surface 1b. Thus, in a case where the piston 1 is kept floating off the cylinder 3 by means of an air bearing (a form of bearing realized by securing a very small clearance between the piston 1 and the cylinder 3 and filling the clearance with the working medium so as to reduce the sliding load of the piston 1), the working medium flows in and out through the first groove 10a and the effect of the air bearing is thereby maintained.

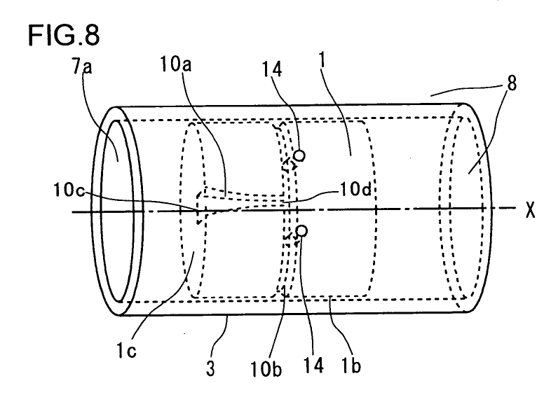

FIG. 8 is a perspective view of the piston and the cylinder of an eighth embodiment of the invention. The piston 1, the first and second grooves 10a and 10b, and the holes 14 are arranged in the same manner as in the fourth embodiment. The first groove 10a is so formed as to have increasingly large cross-sectional areas from one end 10d thereof toward the piston end surface 1c so that the first groove 10a has the maximum cross-sectional area at the other end 10c thereof facing the first space 7a. This helps reduce the energy loss due to the flow of the working medium.

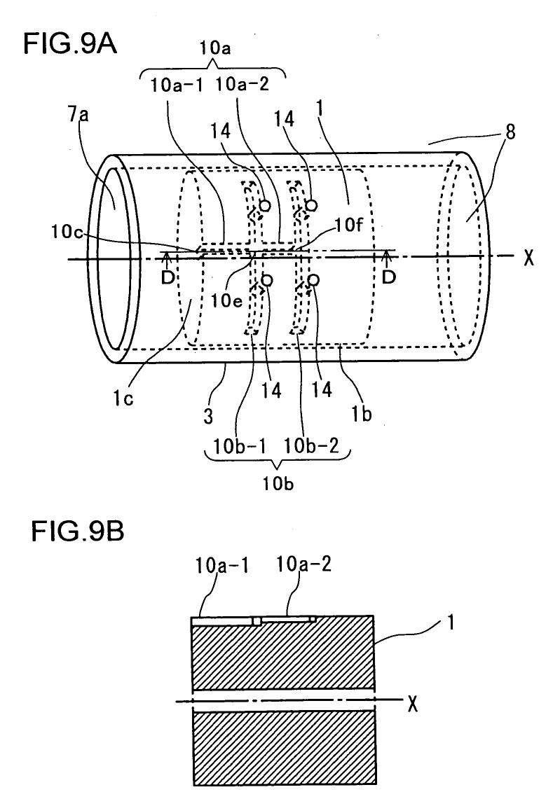

FIG. 9A is a perspective view of the piston and the cylinder of a ninth embodiment of the invention. The piston 1, the first and second grooves 10a and 10b, the holes 14 are arranged in the same manner as in the fifth embodiment. Here, the portion of the first groove 10a between one end 10c thereof facing the first space 7a and the root portion of the first 10b-1 of the second grooves as counted from the first space 7a side is referred to as the portion 10a-1, and the portion of the first groove 10a between the root portion of the first 10b-1 of the second grooves as counted from the first space 7a side and the root portion of the second 10b-2 of the second grooves as counted from the first space 7a side is referred to as the portion 10a-2. FIG. 9B is a sectional view taken along line D-D shown in FIG. 9A. As shown in FIG. 9B, the portion 10a-1 has a larger cross-sectional area than the portion 10a-2.

Specifically, the cross-sectional area of the second grooves 10b-1 and 10b-2 as measured along their shorter sides is made equal to the diametrical cross-sectional area of one hole 14, the cross-sectional area of the portion 10a-2 of the first groove as measured along their shorter sides is made equal to the total diametrical cross-sectional area of two holes 14a, and the cross-sectional area of the portion 10a-1 of the first groove as measured along their shorter sides is made equal to the total diametrical cross-sectional area of four holes 14a. This makes it possible to secure the minimum cross-sectional areas of the first and second grooves 10a and 10b so that, when the second grooves 10b-1 and 10b-2 communicate with the holes 14, the working medium can flow without pressure loss. In this way, it is possible to minimize the energy loss due to the flow of the working medium.

In any of the embodiments described above, the first and second grooves 10a and 10b can be formed, for example, by lathing or by milling using an end mill, and the holes can be formed by drilling alone. That is, the grooves and holes can both be formed easily and cheaply.

Industrial Applicability

In a Stirling-cycle engine according to the present invention, it is possible to shorten the time for which the first and second grooves formed on the piston and the holes formed in the side wall of the cylinder communicate with each other when the piston is driven to move, and thereby stabilize the center position of the reciprocating movement of the piston.

The first and second grooves and the holes are formed as grooves and holes that are easy to form, and can thus be formed cheaply.

Moreover, in a Stirling-cycle engine according to the present invention, the first and second grooves can be so formed as to have a cross-sectional area required to permit the flow of the working medium and have a cross-sectional shape of which the depth is greater than the width. Thus, in a case where the piston is kept floating off the cylinder by means of an air bearing, the working medium flows in and out through the first and grooves and the effect of the air bearing is thereby maintained.

Furthermore, in a Stirling-cycle engine according to the present invention, it is possible to secure the minimum cross-sectional area of the first and second grooves required to permit the flow of the working medium, and thereby minimize the gas flow loss that occurs as the working medium flows through the first and second grooves.

1. A Stirling-cycle engine comprising a piston that reciprocates inside a cylinder and a displacer that reciprocates inside the cylinder as a result of a working medium being compressed or expanded by the reciprocating movement of the piston, the piston and the displacer being arranged so that center axes thereof coincide with a center axis of the cylinder, the Stirling-cycle engine having a first space formed between the displacer and the piston, a second space formed so as to extend from a side of the piston facing away from the displacer and include a portion adjacent to at least part of a side wall of the cylinder, a third space formed on a side of the displacer facing away from the piston, a first groove formed so as to run from an end surface of the piston facing the first space in a direction of the reciprocating movement, and a second groove formed all around a periphery of the piston so as to start and end at one point on the first groove, and a hole formed through the side wall of the cylinder, the Stirling-cycle engine being so structured that, when the piston is in a center position of the reciprocating movement thereof, the second grove and the hole connect to each other so that the first and second spaces communicate with each other,
wherein an opening of the hole has a shape of an elongate circle or a rectangle having a minor axis or shorter sides thereof aligned with the direction of the reciprocating movement of the piston.

2. A Stirling-cycle engine comprising a piston that reciprocates inside a cylinder and a displacer that reciprocates inside the cylinder as a result of a working medium being compressed or expanded by the reciprocating movement of the piston, the piston and the displacer being arranged so that center axes thereof coincide with a center axis of the cylinder, the Stirling-cycle engine having a first space formed between the displacer and the piston, a second space formed so as to extend from a side of the piston facing away from the displacer and include a portion adjacent to at least part of a side wall of the cylinder, a third space formed on a side of the displacer facing away from the piston, a first groove formed so as to run from an end surface of the piston facing the first space in a direction of the reciprocating movement, and a second groove formed all around a periphery of the piston so as to start and end at one point on the first groove, and a hole formed through the side wall of the cylinder, the Stirling-cycle engine being so structured that, when the piston is in a center position of the reciprocating movement thereof, the second grove and the hole connect to each other so that the first and second spaces communicate with each other,
wherein the hole consists of a plurality of such holes arranged along the second groove.

3. A Stirling-cycle engine as claimed in claim 2, wherein the second groove is so formed that a depth thereof is greater than a width thereof as viewed in a cross section thereof.

4. A Stirling-cycle engine as claimed in claim 2, wherein the first groove is so formed that a depth thereof is greater than a width thereof as viewed in a cross section thereof.

5. A Stirling-cycle engine as claimed in claim 2, wherein the first groove has increasingly large cross-sectional areas from one end thereof toward the end surface of the piston so that the first groove has a maximum cross-sectional area at another end thereof facing the first space.

6. A Stirling-cycle engine as claimed in one of claims 1 to 5, wherein the second groove consists of a plurality of such grooves arranged along the first groove.

7. A Stirling-cycle engine as claimed in one of claims 1 to 5, wherein the second groove consists of n such grooves arranged along the first groove, and portions of the first groove between a root portion of the (n−1)th of the second grooves as counted from the first space side and a root portion of the nth of the second grooves as counted from the first space side have increasingly large cross-sectional areas from one end of the first groove toward the first space so that the first groove has a maximum cross-sectional area between another end thereof facing the first space and a root portion of the first of the second grooves as counted from the first space side.

8. A Stirling-cycle engine comprising a piston that reciprocates inside a cylinder and a displacer that reciprocates inside the cylinder as a result of a working medium being compressed or expanded by the reciprocating movement of the piston, the piston and the displacer being arranged so that center axes thereof coincide with a center axis of the cylinder, the Stirling-cycle engine having a first space formed between the displacer and the piston, a second space formed so as to extend from a side of the piston facing away from the displacer and include a portion adjacent to at least part of a side wall of the cylinder, a third space formed on a side of the displacer facing away from the piston, a first groove formed so as to run from an end surface of the piston facing the first space in a direction of the reciprocating movement, and a second groove formed in a periphery of the piston so as to extend from one point on the first groove perpendicularly to the first groove, and a hole formed through the side wall of the cylinder,
the Stirling-cycle engine being so structured that, when the piston is in a center position of the reciprocating movement thereof, the second grove and the hole connect to each other so that the first and second spaces communicate with each other,
wherein an opening of the hole has a shape of an elongate circle or a rectangle having a minor axis or shorter sides thereof aligned with the direction of the reciprocating movement of the piston.

9. A Stirling-cycle engine comprising a piston that reciprocates inside a cylinder and a displacer that reciprocates inside the cylinder as a result of a working medium being compressed or expanded by the reciprocating movement of the piston, the piston and the displacer being arranged so that center axes thereof coincide with a center axis of the cylinder, the Stirling-cycle engine having a first space formed between the displacer and the piston, a second space formed so as to extend from a side of the piston facing away from the displacer and include a portion adjacent to at least part of a side wall of the cylinder, a third space formed on a side of the displacer facing away from the piston, a first groove formed so as to run from an end surface of the piston facing the first space in a direction of the reciprocating movement, and a pair of second grooves formed so as to branch off one point on the first groove in a fashion symmetric with respect to the first groove in a periphery of the piston, and a hole formed through the side wall of the cylinder,
the Stirling-cycle engine being so structured that, when the piston is in a center position of the reciprocating movement thereof, the second grove and the hole connect to each other so that the first and second spaces communicate with each other,
wherein the hole consists of a plurality of such holes arranged for each of the pair of second grooves.

10. A Stirling-cycle engine as claimed in claim 9, wherein the second groove is so formed that a depth thereof is greater than a width thereof as viewed in a cross section thereof.

11. A Stirling-cycle engine as claimed in claim 9, wherein the first groove is so formed that a depth thereof is greater than a width thereof as viewed in a cross section thereof.

12. A Stirling-cycle engine as claimed in claim 9, wherein the first groove has increasingly large cross-sectional areas from one end thereof toward the end surface of the piston so that the first groove has a maximum cross-sectional area at another end thereof facing the first space.

13. A Stirling-cycle engine as claimed in one of claims 8 to 12, wherein the second groove consists of a plurality of such grooves arranged along the first groove.

14. A Stirling-cycle engine as claimed in one of claims 8 to 12, wherein the second groove consists of n such grooves arranged along the first groove, and portions of the first groove between a root portion of the (n−1)th of the second grooves as counted from the first space side and a root portion of the nth of the second grooves as counted from the first space side have increasingly large cross-sectional areas from one end of the first groove toward the first space so that the first groove has a maximum cross-sectional area between another end thereof facing the first space and a root portion of the first of the second grooves as counted from the first space side.
